(19) United States
(12) Patent Application Publication
(10) Pub. No.: US 2005/0172601 A1
(43) Pub. Date: Aug. 11, 2005

(54) Rotary lawn mower blade

(75) Inventor: Patrick Besogne, Vendat (FR)

Correspondence Address: YOUNG & THOMPSON, 745 SOUTH 23RD STREET, 2ND FLOOR, ARLINGTON, VA, 22202, US

(73) Assignee: PBL SA, Saint-Pierre D'Exideuil (FR)

(21) Appl. No.: 10/514,731

(22) PCT Filed: May 20, 2003
(86) PCT No.: PCT/FR03/01519

(30) Foreign Application Priority Data
May 21, 2002 (FR) 02/06164

(51) Int. Cl. A01D 34/52

(52) U.S. Cl. 56/295

(57) ABSTRACT

A lawn mower blade or the like consisting of a rectangular elongated and flattened plate (2) including in its center a bore (3) bordered on either side with holes (4) for its being fixed to a rotating drive shaft, the blade having a leading edge (7), a trailing edge (8) and a raised part (9) located proximate each end of the blade, while each leading edge (1) and trailing edge (8) has, relative to a horizontal plane containing the plate (2), a chamfered profile (6) which is provided with an angle (β) ranging between 0 and 30 degrees and the chamfered profile (6) includes a tapered terminal tip (10) whose land thickness d ranges between 0.1 and 0.5 millimeters.

The present invention relates to a rotatable lawnmower blade comprising more particularly means for lowering the sound level.

There is known according to French patent FR 2611422 a lawnmower blade constituted by an elongated and flattened slat comprising securement recesses, sharp edges, and phased trailing edges on its end portions.

The trailing edges are chamfered over at least one of the raised portions, but preferably over all the trailing edge.

The object of the present invention consists in defining a particular profile of the mower blade so as considerably to lower the sound level due to the rotation of said blade about its drive axis.

The lawnmower blade or the like according to the present invention is constituted by a plate of elongated rectangular and flattened shape, comprising at its middle a bore with holes on opposite sides permitting its securement to a rotatable drive shaft, said blade comprising a leading edge, a trailing edge and a raised portion located adjacent each end of the blade, whilst each leading edge and trailing edge has, relative to a horizontal plane containing the plate, a beveled profile which is provided with an inclination (β) comprised between 0 and 30 degrees and in that the beveled profile comprises a tapered end point whose thickness d is comprised between 0.1 and 0.5 millimeter.

The lawnmower blade or the like according to the present invention comprises a tapered end point whose thickness d is constant over all the length of the beveled edge.

The lawnmower blade or the like according to the present invention comprises a plate having edges which are, relative to a horizontal plane containing said plate, inclined at an angle (α) so as to constitute a blade in the shape of a deformed parallelogram.

The lawnmower blade or the like according to the present invention comprises a plate having edges which are, relative to a vertical plane cutting said plate, inclined at an angle (δ) such that said edges will be directed inwardly of the blade.

The lawnmower blade or the like according to the present invention comprises a plate having at each end a raised portion which is more particularly provided at each trailing edge.

The lawnmower blade or the like according to the present invention comprises leading edges having on each beveled profile at least one notch.

The lawnmower blade or the like according to the present invention comprises trailing edges having on each beveled profile at least one notch.

The lawnmower blade or the like according to the present invention comprises a notch comprising a first flank which is inclined at an angle (φ) relative to a horizontal plane containing the leading edge and a second flank disposed perpendicularly to said edge, said flanks being joined to each other by a curved profile.

The lawnmower blade or the like according to the present invention comprises a notch whose bottom profile is provided to be disposed at a certain distance a from the horizontal axis of the plate.

The lawnmower blade or the like according to the present invention comprises trailing edges having on each raised portion a notch having an inclined flank.

The lawnmower blade or the like according to the present invention comprises on its trailing edge and more particularly between its central bore and its raised portion, a beveled edge with an undulant profile constituted by other raised portions of different lengths and heights.

The lawnmower blade or the like according to the present invention comprises a raised portion whose inclination is variable or increasing from the trailing edge to the center of the plate.

The characteristics and advantages of the present invention will be set forth in detail in the following description of particular embodiments given in a non-limiting way with regard to the accompanying drawings.

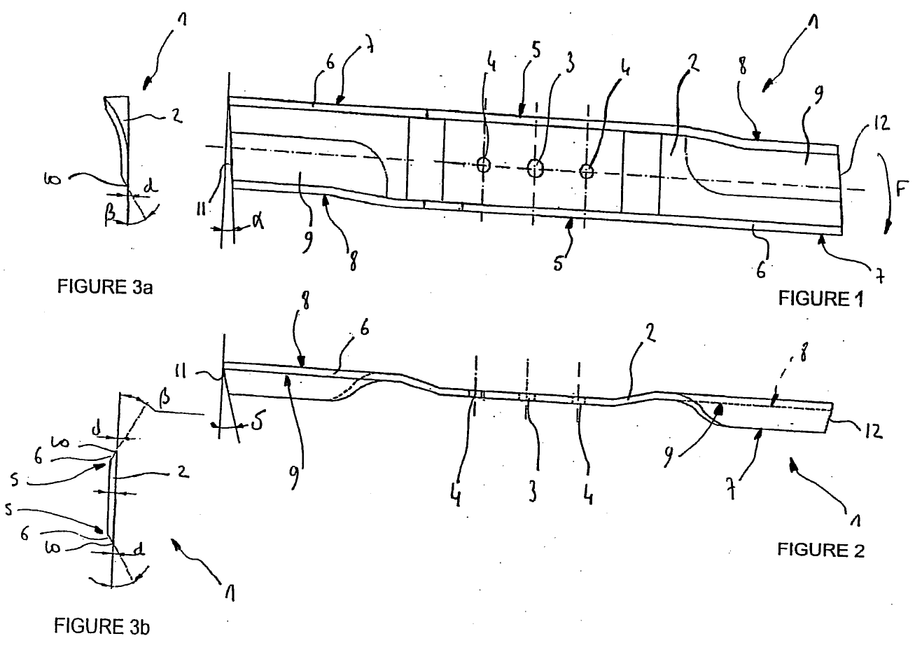

FIG. 1 is a plan view showing the mower blade according to the present invention.

FIG. 2 is a side view showing the profile of the mower blade according to the present invention.

FIGS. 3a and 3b are cross-sectional views showing the inclination of the leading and trailing edges of the mower blade according to the present invention.

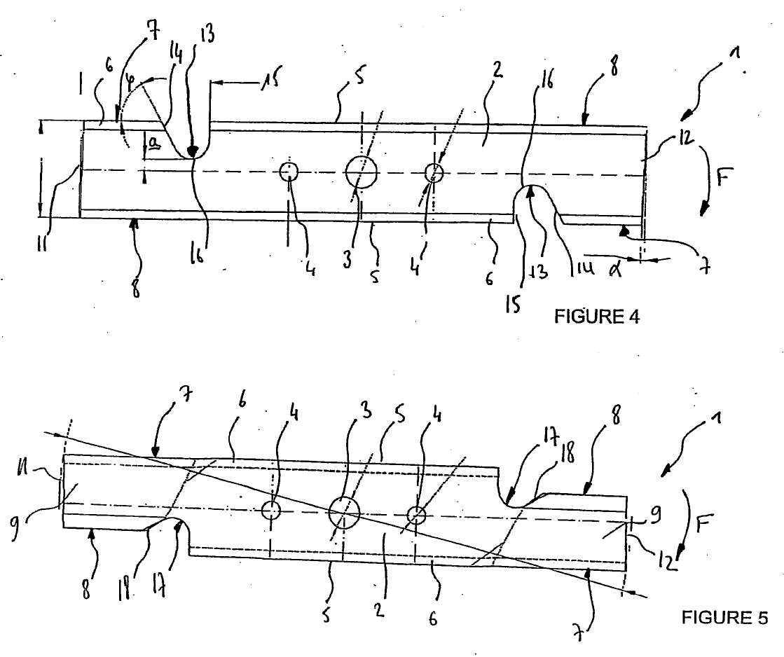

FIGS. 4 and 5 are views showing a first modification of the mower blade according to the present invention.

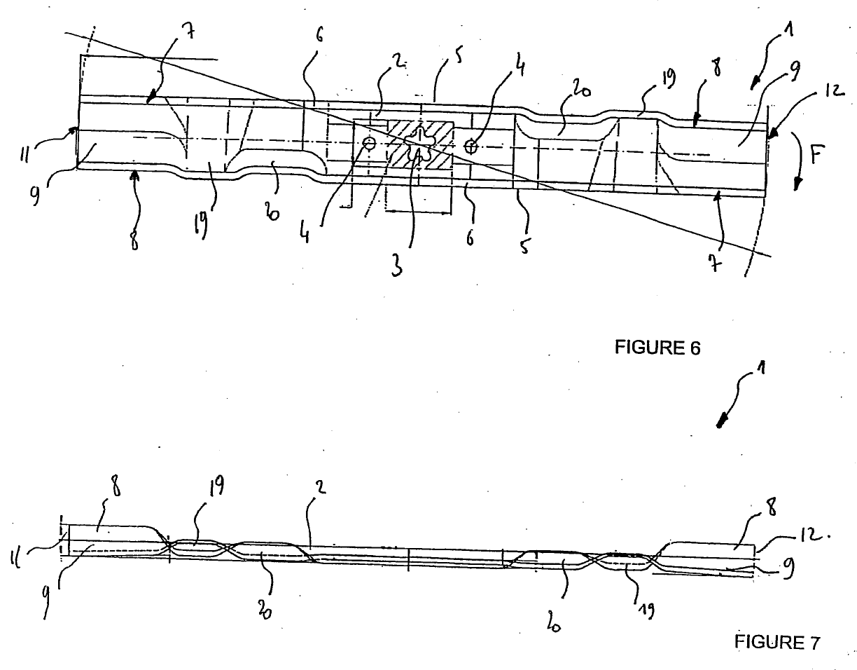

FIGS. 6 and 7 are views showing a second modification of the mower blade according to the present invention.

There is shown in FIGS. 1, 2, 3a and 3b a mower blade 1 which is constituted by a point 2 of elongated and flattened rectangular shape. The point 2 comprises at its middle a bore 3 and on opposite sides of this latter two other holes 4 permitting its securement to a drive shaft of a mower (not shown).

The axis of bore 3 which is disposed perpendicularly to the plane of the plate 2 coincides with the axis of the drive shaft of the motor of the mower and constitutes an axis of symmetry for the blade.

The blade 1 comprises on each side an edge 5 which has a continuous beveled profile 6 so as to constitute for each edge and as a function of the direction of rotation F of said blade, a leading edge 7 and a trailing edge 8.

Also, the blade 1 comprises on each side and at the end of the edge 5, a raised portion 9 which is more particularly provided at the level of each trailing edge 8.

Thus, each edge 5 of the blade 1 forms for half of the blade 2 the leading edge 7 and for the other half the trailing edge 8.

It will be noted that the beveled profile 6 of the leading edge 7 constitutes also and in a continuous manner a beveled profile of the trailing edge of each edge 5 of the blade 1.

The continuous beveled edge 6 of the leading edge 7 and of the trailing edge 8 forms, for each edge 5, the cutting portion of the blade 1.

The continuous beveled profile 6 of each leading edge 7 and training edge 8 has, relative to a horizontal plane containing the plate 2, an inclination β comprised between 0 and 30 degrees.

The continuous beveled profile 6 has, for each leading edge 7 and trailing edge 8, a tapered end point 10 whose thickness d is comprised between 0.1 and 0.5 millimeter.

This thickness of the tapered point 10 is constant over all the length of the beveled edge 6 of the blade 1.

The plate 2 has, at each end, opposite edges 11 and 12 which are of lesser length than those 5 with beveled profile 6.

The plate 2 comprises edges 11 and 12 which are, relative to a horizontal plane containing said plate, inclined at an angle α so as to constitute a blade 1 in the form of a deformed parallelogram.

The plate 2 comprises edges 11 and 12 which are, relative to a vertical plane cutting said plate, inclined at an angle δ so that said edges will be directed inwardly of the blade 1.

It will be noted that the continuous beveled profile 6 of the leading edges 7 and trailing edges 8, that the thickness d of the tapered point 10 and that the inclinations of the edges 11 and 12 of the blade 1, contribute to a great reduction of noise when this latter is driven in rotation.

There is shown in FIG. 4 a mower blade 1 according to the present invention comprising on each side an edge 5 which has a beveled profile 6 so as to constitute for each side and as a function of the direction of rotation F for said blade, a leading edge 7 and a trailing edge 8.

The beveled profile 6 comprises at the level of each leading edge 7, a notch 13 penetrating the interior of the plate 2 of the mower blade 1.

The notch 13 has a first flank 14 which is inclined at an angle φ relative to the horizontal plane containing the leading edge 7 and a second flank 15 disposed perpendicularly to said edge. The two flanks 14 and 15 are joined to each other by a curved profile 16.

The first flank 14 of each notch 13 is inclined in the direction of the edge 11, 12 located adjacent thereto, so as to present the opening of a notch in the direction of rotation F of the mower blade 1.

The bottom of notch 13 formed by the curved profile 16 is provided to be disposed at a certain distance from the horizontal axis of the plate 2.

There is shown in FIG. 5 the mower blade 1 according to the present invention comprising on each side an edge 5 which has a beveled profile 6 so as to constitute, for each side and as a function of the direction of rotation F of said blade, a leading edge 7 and a trailing edge 8.

The beveled profile 6 comprises at the level of the leading edge 8 and more particularly on each raised portion 9, a notch 17 penetrating the interior of the plate 2 of the mower blade 1.

Again, the notch 17 has a profile similar to that 13 described previously and more particularly an inclined flank 18 directed in the direction of the edges 11, 12 located immediately adjacent the notch.

Thus, the mower blade 1 according to the present invention comprises a discontinued beveled edge 6 because of the notches 13 and 17 disposed either on the leading edge 7 or on the trailing edge 8.

There is shown in FIGS. 6 and 7 the mower blade 1 according to the present invention comprising on each side an edge 5 which has a beveled profile 6 so as to constitute, for each side and as a function of the direction of rotation F of said blade, a leading edge 7 and a trailing edge 8.

The mower blade 1 comprises on its trailing edge 8 and more particularly between its central bore 3 and its raised portion 9, a beveled edge 6 with an undulant profile.

Thus, the beveled edge 6 comprises, from the raised portion 9 up to the middle of the plate 2, other raised portions 19, 20 of different length and width.

It will also be noted that the central bore 3 of mower blade 1 can have a star profile.

It will be noted that the mower blade 1 according to the present invention can comprise a raised portion 9 whose inclination is variable or increasing from the trailing edge 8 to the center of the plate 2.

It should also be understood that the description which precedes was given only by way of example and that it in no way limits the scope of the invention, from which one would not depart by replacing the described details of execution by any other equivalent.

1. Lawnmower blade or the like constituted by a plate (2) of elongated and flattened rectangular shape comprising at its middle a bore (3) bordered on opposite sides by holes (4) permitting its securement to a rotatable drive shaft, said blade comprising a leading edge (7), a trailing edge (8) and a raised portion (9) located adjacent each end of the blade, characterized in that each leading edge (7) and trailing edge (8) has, relative to a horizontal plane containing the plate (2), a beveled profile (6) which is provided with an inclination (β) comprised between 0 and 30 degrees and in that the beveled profile (6) comprises a tapered end point (10) whose thickness d is comprised between 0.1 and 0.5 millimeter.

2. Lawnmower blade or the like according to claim 1, characterized in that the thickness d of the tapered point (10) is constant over all the length of the beveled edge (6) of the blade (1)

3. Lawnmower blade or the like according to claim 1, characterized in that the plate (2) comprises edges (11, 12) which are, relative to a horizontal plane containing said plate, inclined at an angle (α) so as to constitute a blade (1) in the shape of a deformed parallelogram.

4. Lawnmower blade or the like according to claim 1, characterized in that the plate (2) comprises edges (11, 12) which are, relative to a vertical plane cutting said plate, inclined at an angle (δ) such that the edges will be directed inwardly of the blade (9).

5. Lawnmower blade or the like according to claim 1, characterized in that the plate (2) comprises at each end a raised portion (9) which is more particularly provided at each trailing edge (8).

6. Lawnmower blade or the like according to claim 1, characterized in that each leading edge (7) comprises on its beveled profile (6) at least one notch (13).

7. Lawnmower blade or the like according to claim 1, characterized in that each trailing edge (8) comprises on its beveled profile (6) at least one notch (17).

8. Lawnmower blade or the like according to claim 6, characterized in that the notch (13) comprises a first flank (14) which is inclined at an angle (φ) relative to a horizontal plane containing the leading edge (7) and a second flank (15) disposed perpendicularly to said edge, said flanks (14, 15) being connected to each other by a curved profile (16).

9. Lawnmower blade or the like according to claim 8, characterized in that the bottom of the notch (13) formed by the curved profile (16) is provided to be disposed at a certain distance from the horizontal axis of the plate (2).

10. Lawnmower blade or the like according to claim 7, characterized in that each trailing edge (8) comprises on each raised portion (9) a notch (17) having an inclined flank (18).

11. Lawnmower blade or the like according to claim 1, characterized in that it comprises at its trailing edge (8) and more particularly between its central bore (3) and its raised portion (9), a beveled edge (6) with an undulant profile constituted by other raised portions (19, 20) of different lengths and heights.

12. Lawnmower blade or the like according to claim 1, characterized in that it comprises a raised portion (9) whose inclination is variable or increasing from the trailing edge (8) to the center of the plate (2).
